(19) United States
(12) Patent Application Publication
(10) Pub. No.: US 2014/0175023 A1
(43) Pub. Date: Jun. 26, 2014

(54) THREE WIRE PRESS SOLIDS DEWATERING METHOD AND APPARATUS FOR OIL AND GAS FIELD APPLICATIONS

(71) Applicant: WSI International, LLC, Centennial, CO (US)

(72) Inventors: Alfred TYLER, Annapolis, MD (US); William Michael FIELDS, Centennial, CO (US)

(73) Assignee: WSI International, LLC, Centennial, CO (US)

(21) Appl. No.: 14/134,796

(22) Filed: Dec. 19, 2013

Related U.S. Application Data
(60) Provisional application No. 61/740,124, filed on Dec. 20, 2012.

(51) Int. Cl. B01D 33/41; B01D 33/044; B01D 33/00; B01D 33/64

(52) U.S. Cl. CPC B01D 33/41; B01D 33/642; B01D 33/044; B01D 33/0067
USPC 210/749; 210/770; 210/391; 210/330; 210/396; 210/90

(57) ABSTRACT

A three wire press solids dewatering device and method for unconventional oil and gas field solids management applications, including drilling mud dewatering in a closed-loop drilling system, as well as solids dewatering in flow back and produced water treatment systems, including a single wire belt gravity thickener for inlet solids slurry thickening and distribution, and a twin wire press for thickened solids slurry dewatering.

### BACKGROUND OF THE INVENTION

Recent technical developments in horizontal drilling and hydraulic fracturing (“fracking”) has created the opportunity to access and utilize new, unconventional oil and natural gas reserves. The hydraulic fracking process includes well construction, well stimulation, and waste disposal. However, the surface disturbance and waste management in the hydraulic fracking process has caused public concern. In particular, the management and disposal of solid waste has posed a significant challenge in this form oil and gas exploration and production.

The solid wastes resulting from this form of oil and gas production are mainly generated from the well drilling, the hydraulic fracking itself, and oil and gas production. In most of these applications, earthen reserve pits are excavated for the disposal of drilling muds and well cuttings. A tank battery is used to separate the oil and solids from the produced-water resulting from the hydraulic fracking process. The water produced by this process includes flowback water as well as water from geological formations. A slope tank is used to hold and concentrate the solids settled from the produced-water tank battery.

In order to minimize the drilling mud solids and to reduce the costs of solids management, a closed-loop drilling process is frequently adopted by oil and gas operators. The typical closed-loop drilling system consists of a shale shaker, a sand and silt removal unit, a centrifugal solids dewatering unit, and integral drilling mud tanks. However, the centrifugal dewatering unit is inefficient because of low dewatered solids consistency, high operational and maintenance costs, and high energy consumption. Further, although the produced-water tank battery removes a majority of the oil, the solids in the slop tank still contain some oils and the solids consistency is usually less than 1-5%.

### SUMMARY OF THE INVENTION

The present invention described below addresses the foregoing solids management, combining the technologies of solids thickening and dewatering together to provide a compact, mobile, less maintenance solution. In addition to the oil and gas applications described above, this invention can also be applied in heavy solids dewatering applications in conventional oil and gas production, food processing, and as municipal wastewater treatment systems.

In accordance with the invention, a three wire press solids dewatering (TWPSD) system of the invention comprises two sections:
Section I a Single Wire Belt Gravity Solids Thickening
Section II a Twin Wire Press for Solids Dewatering

1. Single Wire Belt Gravity Solids Thickening:
Polymers or coagulants are added into an inlet slurry for conditioning. The chemical conditioned slurry flows into the single wire gravity solids thickening section. Solids are concentrated while free water drains by gravity through a single wire porous synthetic belt.
For a produced water treatment application, the settled solids consistency is usually less than 1-3%. The single wire gravity solids thickening section will concentrate the solids consistency to 4-8%.
For the closed-loop drilling applications, the inlet solid consistency may be as high as 6-10%. The single wire belt gravity solids thickening section mainly serves to evenly distribute the feed solids slurry.
In addition, the multi-stations chemical washing system is installed over the single wire porous synthetic belt to use chemicals, such as hydrogen peroxide, as well as water, to remove total petroleum hydrocarbons (TPHs) from the inlet solids slurry.

2. Twin Wire Press Solids Dewatering:
The thickened, or evenly distributed solid slurry, will move into the twin wedge wire press section for dewatering. In this section, two wedge wire moving belts will entrap in a uniform thin layer of slurry between two endless, porous synthetic belts. Mechanical pressure is then applied to the belts so as to force a major portion of the water (filtrate) from the solids as it traverses the machine.
The dewatered solids consistency could be 40-60% for drilling mud dewatering in closed-loop drilling system and 25-40% for produced water solids dewatering.

The three wire press in accordance with the invention delivers substantial improvement over the performance of the centrifugal dewatering unit described above, producing 40-60% dry solids with significantly less cost in operation and maintenance, and a required horsepower that is only about 1/15- 1/10 that of the above-described centrifuge. Further, a single wire belt solids thickening section in the three wire press of the invention can further concentrate the solids consistency to 6-10% over the 1-5% of the closed-loop drilling system described above, and a subsequent twin wire press section will dewater the solids to 25-40%. The invention thus significantly reduces the final solids disposal volume in the produced water treatment system and saves on the costs of final disposal when compared with the typical closed-loop system described above.

### BRIEF DESCRIPTION OF THE DRAWINGS

FIG. 1 is a front view of a TWPSD system in accordance with the invention; and

FIG. 2 is a top view of the TWPSD system.

### DETAIL DESCRIPTION OF THE INVENTION

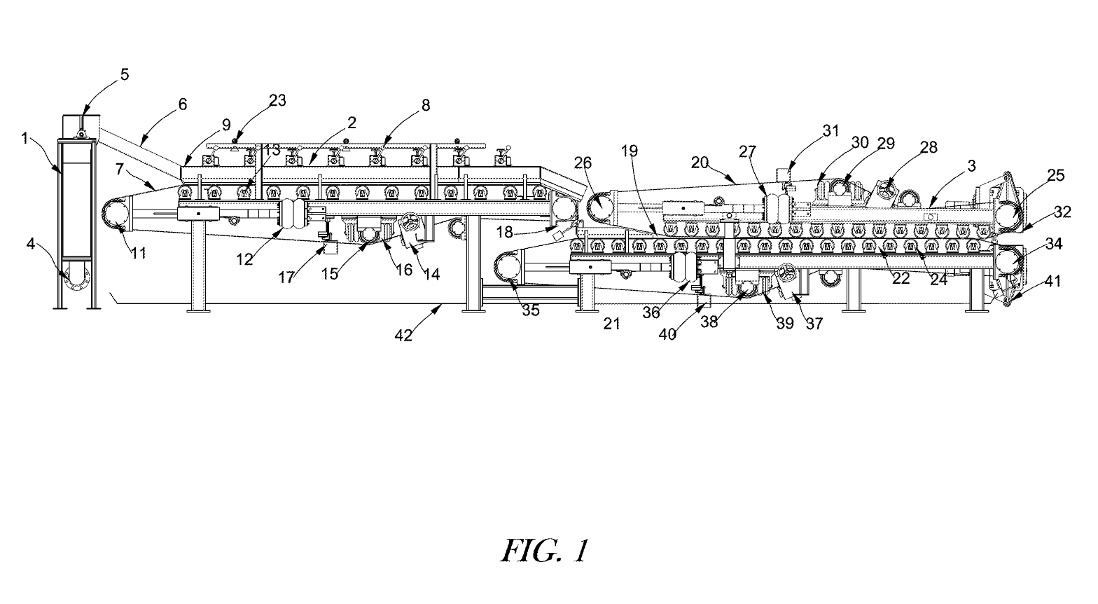

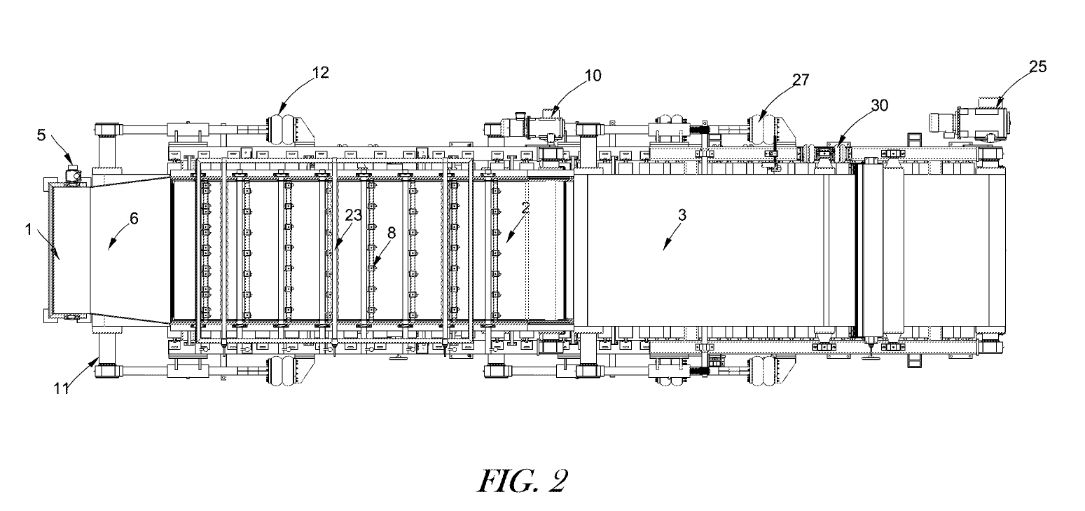

FIGS. 1-2 illustrate an exemplary embodiment of the TWPSD system of the invention. Principle units of the TWPSD system include inlet solid distribution chamber 1, single wire belt gravity solids thickening section 2, and twin wire press solids dewatering section 3.

The solids distribution chamber 1 is a reverse truncated pyramid to reduce the solids uprising velocity and the turbulence so as to protect the fragile flocs. The inlet solid slurry is conditioned with the polymer and flocculants before entering the inlet pipe 4 at the bottom of the solid distribution chamber 1. A rotating paddle 5 is mounted on the top of the solid distribution chamber 1 to scoop the solids into a gradually opened distribution chute 6. The solids are then evenly distributed to the top of a single weir porous synthetic belt 7. Eight series of adjustable plows (chicanes) 8 are mounted over the single wire porous synthetic belt 7 to gently move forward the solids slurry layer. The multi-station chemical washing system 23 consists of 3 rows of spray nozzles for spraying oxidant (e.g., hydrogen peroxide) and water over the solids slurry layer riding on the single wire porous synthetic belt 7 to remove total petroleum hydrocarbons (TPHs). Side plates 9 constrain the solids inside the belt area as the solids slurry moves through the gravity zone. The drive roll 10 has a gear motor mounted on the end for initiating the movement of belt 7. A breast tension roll 11 has air bellows 12 mounted on both ends to apply pressure to the belt. A series of gravity rolls 13 are mounted underneath the single wire belt. The belt shower box 14 consists of a shower header with spray nozzles, adjustable horse-hair or nylon brushes, and a catchment pan with drain. A tracking roll 15 is installed in front of the belt shower box 14 and the air bellows 16 is mounted on the end. A steering valve assembly 17 is used to compensate for occasional alignment issues created by variable solids cake thickness and/or solids consistency fluctuations. An adjustable doctor blade 18 is situated against the drive rolls 10 to remove any solids attached on the surface of the single wire belts 7. The filtrate from the single wire porous synthetic belt 7 is collected in the catchment pan 42 below.

The twin wire press solids dewatering section 3 includes a wedge zone 19 and an “S” roll zone 20. The wedge zone 19 entraps the gravity thickened solids slurry from the single wire belt solids thickening section 2 and forms a solids sheet between the top porous synthetic wire belt 20 and the bottom porous synthetic wire belt 21. An initial pressure of 2 to 6 psi is imparted on the entrapped solids cake as it traverses the narrow end for the initial compression. Then the entrapped solid cake enters the “S” roll zone 22. The solids cake from the end of the wedge zone enters the “S” roll zone 22 under the pressure from the top belt and bottom belt. The filtrate departs from the solids cake outward through both belts and drains to the “S” roll zone filtrate catchment pan 42 below. The solids cake then passes over a series of “S” rolls 24 to complete the compression sequence and is released at the end of “S” roll zone 22.

The top belt 20 is driven by the top drive roll 25 which has a gear motor mounted on the end. A top breast tension roll 26 has the top air bellows 27 mounted on both ends to apply pressure to the belt. The top belt shower box 28 includes a shower header with spray nozzles, adjustable horse-hair or nylon brushes, and a catchment pan with drain. A top tracking roll 29 is installed in front of the top belt shower box and has air bellows 30 mounted on the end. A top steering valve assembly 31 is used to compensate for occasional alignment issues created by variable solids cake thickness and/or solids consistency fluctuations. A top adjustable doctor blade 32 is situated against the top drive rolls 25 to remove any solids attached on the surface of the top belt 20. The filtrate from the top porous synthetic wire belt 20 is collected in the catchment pan 33 below.

The bottom belt 21 is driven by a bottom drive roll 34 which has a gear motor mounted on the end. The bottom breast tension roll 35 has bottom air bellows 36 mounted on both ends to apply pressure to the belt 21. The bottom belt shower box includes a shower header with spray nozzles, adjustable horse-hair or nylon brushes, and a catchment pan with drain. The bottom tracking roll 38 is installed in front of the bottom belt shower box 37 and has air bellows 39 mounted on the end. A bottom steering valve assembly 40 is used to compensate for occasional alignment issues created by variable solids cake thickness and/or solids consistency fluctuations. A bottom adjustable doctor blade 41 is situated against the bottom drive rolls 34 to remove any solids attached on the surface of the bottom belt 21. The filtrate from the bottom belt 21 is collected in the catchment pan 42 below.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

We claim:

1. A method for solids dewatering in oil and gas applications, comprising the steps of:
with a single wire belt gravity solids thickening unit, reducing an uprising velocity and turbulence of inlet solids with a reverse truncated pyramid distribution chamber to produce an inlet solid slurry in order to protect fragile flocs entering with the inlet solids;
concentrating the inlet solids slurry on a single wire porous synthetic belt to produce a thickened solids sheet;
moving the thickened solids sheet to a twin wire press solids dewatering section, and removing a first filtrate collected in a catchment pan underneath the single wire belt solids thickening unit;
with a twin wire press solids dewatering unit, entrapping a thickened solids slurry received from the single wire belt gravity solids thickening unit in a wedge zone;
compressing the thickened solids slurry in an “S” roll zone; and
collecting a second filtrate in filtrate catchment pans provided with the twin wire press solids dewatering unit.

2. The method according to claim 1, wherein the single wire belt solids thickening unit smoothly and evenly distributes the inlet solids in a closed-loop drilling system.

3. The method according to claim 1, wherein the single wire belt solids thickening unit concentrates the inlet solids slurry, as well as smoothly and evenly distributes the inlet solids slurry in a water or wastewater treatment solids handling system.

4. The method according to claim 1, wherein a multi-station chemical washing system removes TPHs from the inlet solids slurry.

5. A single wire belt solids thickening unit, comprising:
a reverse truncated pyramid distribution chamber;
a gradually opened distribution chute;
a series of adjustable plows (chicanes) for solids slurry distribution;
a single wire porous synthetic belt;
a belt drive system including rolls to drive and guide the synthetic belt, the belt drive system configured to provide variable speed motion/power to the synthetic belt;
a belt tensioning system to apply individual tension pressure to the synthetic belt;
a belt alignment system to control the tracking side to side of the belt and to keep the belt in a center of the rolls of the belt drive system; and
a belt shower system to thoroughly clean the belt.

6. A twin wire press solids dewatering unit, comprising:
a top wire belt system and a bottom wire belt system, each belt system including
a porous synthetic wire belt,
a belt drive system to provide variable speed motion/power to the belt,
a belt tensioning system to apply individual tension pressure to the belt,
a belt alignment system to control the tracking side to side of the belts and to keep them in the center of the rolls,
a belt shower system to thoroughly clean the belts.

7. The single wire belt solids thickening unit according to claim 5, wherein the belt drive system includes a doctor blade to remove attached solids on the belt, a 19-inch drive roll, an angle gear drive box, and a 7.5 hp motor variable frequency drive.

8. The single wire belt solids thickening unit according to claim 5, further comprising:
a 12¾ø breast tension roll;
an air pressure bellows assembly to apply force to the breast tensioning roll thrust shafts;
stainless steel thrust shafts connected with an alignment shaft and gears; and
an air flow and pressure control panel.

9. The single wire belt solids thickening unit according to claim 5, further comprising:
an 8″ belt alignment roll and bearings;
an air bellows pneumatic longitudinal belt alignment assembly;
a paddle stand, air control valve and belt edge sensor paddle assembly;
a whisker switches situated adjacent to the paddles for immediate STOP of the belt in the event of an alignment or tension malfunction; and
a set of air pressure gauges and control valves.

10. The single wire belt solids thickening unit according to claim 5, further comprising:
a shower box;
a shower nozzle hand wheel controlled cleaning brushes with an iatrical valve position to flush nozzle debris from the shower header;
an 1½″ stainless steel shower header with 31 stainless steel nozzles positioned;
a hand wheel controlled, shaft mounted, brass cleaning brush;
an adjustable horse-hair or nylon brush;
a shower water catchment pan with drain; and
an adjustable shower spray containment blades with EPDM wipers.

11. The twin wire press solids dewatering unit according to claim 6, further comprising:
a 12¾ø breast tension roll;
an air pressure bellows assembly to apply force to the breast tensioning roll thrust shafts;
a set of stainless steel thrust shafts connected with an alignment shaft and gears; and
an air flow and pressure control panel.

12. The twin wire press solids dewatering unit according to claim 6, further comprising:
an 8″ belt alignment roll and bearings;
an air bellows pneumatic longitudinal belt alignment assembly;
a paddle stand, air control valve and belt edge sensor paddle assembly;
a whisker switches situated adjacent to the paddles for immediate STOP of the belt in the event of an alignment or tension malfunction; and
a set of air pressure gauges and control valves.

13. The twin wire press solids dewatering unit according to claim 6, further comprising:
a shower box;
a shower nozzle hand wheel controlled cleaning brushes with an iatrical valve position to flush nozzle debris from the shower header;
an 1½″ stainless steel shower header with 31 stainless steel nozzles positioned;
a hand wheel controlled, shaft mounted, brass cleaning brush;
an adjustable horse-hair or nylon brush;
a shower water catchment pan with drain; and
an adjustable shower spray containment blades with EPDM wipers.
